(19) United States
(12) Patent Application Publication
(10) Pub. No.: US 2019/0168271 A1
(43) Pub. Date: Jun. 6, 2019

(54) REDUCED EMISSIONS METHOD OF CLEANING HYDROCARBON SEPARATOR AND STORAGE TANKS

(71) Applicant: Pioneer Natural Resources USA, Inc., Irving, TX (US)

(72) Inventors: Bailey WALTON, Irving, TX (US); Jody CONAWAY, Irving, TX (US); Jessica WALLACE, Irving, TX (US)

(21) Appl. No.: 16/206,432

(22) Filed: Nov. 30, 2018

Related U.S. Application Data
(60) Provisional application No. 62/593,748, filed on Dec. 1, 2017.

(51) Int. Cl. B08B 9/08

(52) U.S. Cl. CPC B08B 9/0813; B08B 2209/08

(57) ABSTRACT

A method for cleaning a storage tank, comprising isolating the tank; creating a vortex within the tank by pumping fluid through one or more nozzles disposed within the tank, thereby dislodging sediment within the tank; and connecting a suction source to a drain located on a bottom of the tank, thereby removing the fluid and sediment without exposure to air. Each nozzle may comprise one or more sub-nozzles positioned to direct fluid flow to assist in creation of the vortex and removal of the fluid and sediment. A storage tank, comprising one or more nozzles disposed within the tank such that fluid may be pumped through the nozzles to create a vortex within the tank; and a drain line located on a bottom of the tank such that a suction source may be connected and contents of the tank removed without exposure to air.

### CROSS REFERENCE TO RELATED APPLICATION

This application claims priority to U.S. Provisional Application No. 62/593,748 filed Dec. 1, 2017 and hereby incorporated herein by reference in its entirety.

### BACKGROUND

This disclosure relates generally to the field of maintenance of storage tanks of production liquids, and more specifically to the field of cleaning storage tanks.

A storage tank is an atmospheric tank used for storing and separating output from a well into separate components. For example, some wells produce liquids such as water and oil, gases such as natural gas, solids such as sand and iron sulfide, or some combination thereof. A storage tank allows the different products to settle and separate within the tank and stores production liquids until transport. The separated components are then removed by different outlets. After a period of use, the storage tank may be overfull of solids and need to be cleaned to remove the solids from within the storage tank. Disclosed herein is a method of cleaning a storage tank which may reduce emissions and cleaning down time.

### SUMMARY

Described herein is a method of cleaning a storage tank including isolating the tank; creating a vortex within the tank by pumping fluid through one or more nozzles disposed within the tank, which dislodges sediment within the tank; and connecting a suction source to a drain located on the bottom of the tank, which removes the fluid and sediment from the tank without exposure to air. In some embodiments, isolating the tank includes closing all lines into and out of the tank under a predetermined height except for the one or more nozzles. The predetermined height is chosen based on at least the anticipated height of sediment build-up within the tank and the anticipated volume of fluid required to dislodge the sediment. In some embodiments each nozzle includes one or more sub-nozzles to direct the flow of fluid within the tank to assist in creation of a vortex and removal of the fluid and sediment through the drain.

A storage tank and a nozzle assembly for use in connection with the disclosed method of cleaning a storage tank are also described herein.

### BRIEF DESCRIPTION OF THE DRAWINGS

FIG. 1 shows a storage tank according to one or more embodiments.

FIG. 2 shows a close-up view of a nozzle in a storage tank according to one or more embodiments.

FIG. 3 shows an overhead view of an example arrangement of the nozzles and drain within a storage tank according to one or more embodiments.

FIG. 4 shows, in flow chart form, an example process for cleaning a storage tank according to one or more embodiments.

### DETAILED DESCRIPTION

This disclosure is directed to a storage tank and a method of cleaning storage tanks. According to one or more embodiments, the disclosed method of cleaning storage tanks may be safer and more environmentally friendly, as well as quicker and more efficient, than traditional methods of cleaning storage tanks. The described example storage tanks include one or more nozzles disposed within the tank, through which fluid may be pumped at a sufficient volume and pressure to create a vortex and dislodge sediment within the tank and flush it through a drain located on the bottom of the tank. The number of nozzles within the tank is chosen based on the size of the tank and the sediment to be cleaned from the tank. In some examples, each nozzle includes two or more sub-nozzles, which direct the fluid within the tank to ease creation of the vortex and to flush the sediment and fluid towards the drain. This may reduce the likelihood of clogs in the drain. In some embodiments, a suction source is applied to the drain to facilitate removal of the fluid and sediment within the tank and direct it to an appropriate waste removal system without exposure to air.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be deleted, or the components may be performed in a different order, or even concurrently. In addition, other embodiments may include additional steps not depicted as part of the flow diagram. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers' specific goals (e.g., compliance with system and business-related constraints), and that these goals will vary from one implementation to another. It will also be appreciated that such development efforts might be complex and time consuming, but would nevertheless be a routine undertaking for those of ordinary skill in the art having the benefit of this disclosure.

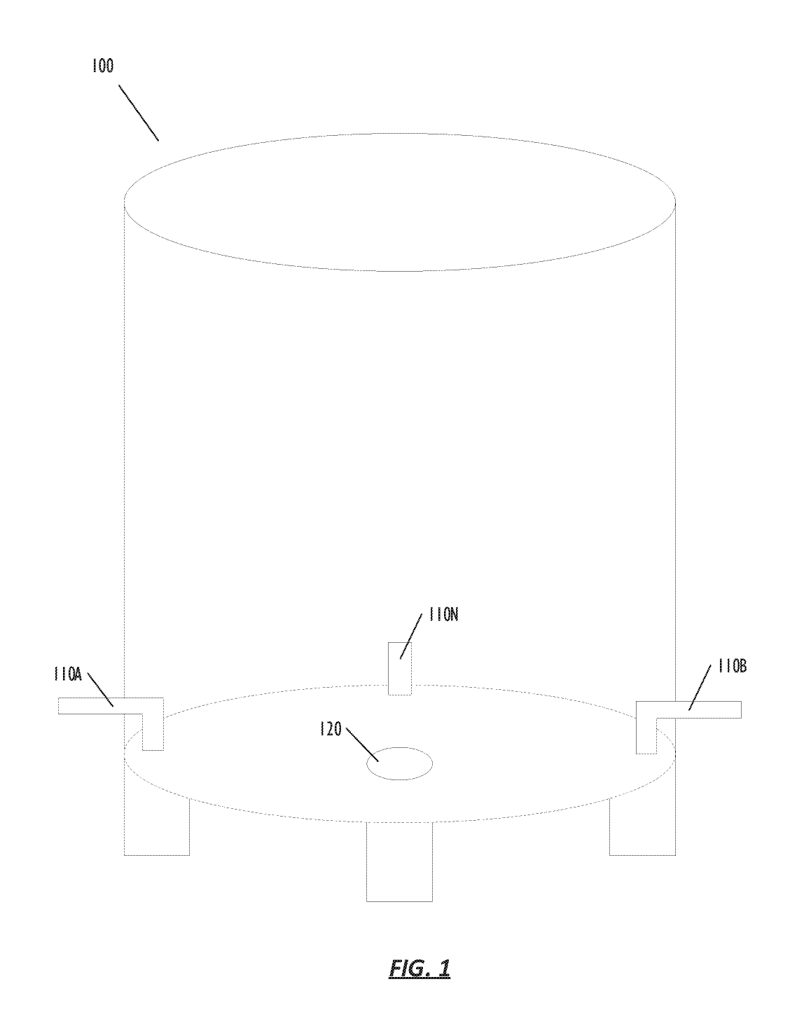

Referring to FIG. 1, an example storage tank 100 is shown, according to one or more embodiments. Storage tank 100 includes nozzles 110A-N and a drain 120. Fluid may be pumped through nozzles 110A-N to create a vortex within storage tank 100 and dislodge sediment within the tank. The dislodged sediment and fluid pumped through nozzles 110A-N may then be drained through drain 120, passively according to the weight of the sediment and fluid or actively according to an external suction force applied to drain 120. Fluid pressure, volume, flow rate, and the like may be chosen based on the size of storage tank 100 and the type of sediment within it. For example, a larger tank requires higher fluid volume and pressure than a smaller tank under the same conditions. Similarly, heavier sediment with larger particles requires higher fluid volume and pressure than lighter sediment with smaller particles.

The number of nozzles 110A-N may be determined based on the size of storage tank 100. Generally, there should be a sufficient number of nozzles 110A-N to dislodge sediment from the entire bottom of storage tank 100. In some embodiments, where the bottom of storage tank 100 is particularly large, a single nozzle 110 may be insufficient because the available fluid pressure decreases over distance until it is insufficient to dislodge the sediment at a point within the tank farthest from the single nozzle. In those embodiments, two or more nozzles 110A-N are implemented according to the size of storage tank 100 and the fluid pressure required to dislodge the sediment. Similarly, the placement of the one or more nozzles 110A-N within storage tank 100 is determined based on the size of storage tank 100. In some embodiments where two or more nozzles 110A-N are implemented, the nozzles 110A-N may be spaced throughout storage tank 100 such that all areas of storage tank 100 experience fluid pressure sufficient to dislodge sediment. For example, where three nozzles 110A-C are implemented in storage tank 100, the nozzles 110A-C may be spaced evenly around the cylindrical sides of storage tank 100, approximately 120 degrees apart. In some embodiments, the one or more nozzles 110A-N are positioned within the tank such that the fluid pressure dislodges the sediment at or near the bottom of storage tank 100. For example, if the one or more nozzles 110A-N are positioned on the side walls of storage tank 100 at a short height off the bottom of storage tank 100, the fluid pressure from the one or more nozzles 110 may be used to dislodge the sediment at the base of storage tank 100 and by extension, substantially all sediment in storage tank 100, rather than merely the top layers of sediment. The position of the one or more nozzles 110A-N at a short height off the bottom of storage tank 100 may also facilitate draining of the fluid and sediment through drain 120 by decreasing the likelihood of clogs in drain 120.

In some embodiments each of the one or more nozzles 110A-N may include one or more sub-nozzles for more efficient dislodgment of sediment within storage tank 100. The number and positioning of sub-nozzles may be chosen to optimize dislodgment of sediment and ease of draining storage tank 100. For example, each nozzle 110 may include two bi-directional sub-nozzles positioned such that one sub-nozzle aids in dislodging sediment from the bottom of storage tank 100 and the second sub-nozzle aids in flushing the fluid and sediment through drain 120.

Storage tank 100 also includes drain 120 located at the bottom of storage tank 100. Fluid pumped through nozzles 110A-N and sediment dislodged by it are removed from storage tank 100 through drain 120. In some embodiments, the fluid and the sediment passively drain through drain 120 according to the weight of the fluid and sediment. In other embodiments, the fluid and sediment actively drain through drain 120 according to an external suction source applied to drain 120. For example, a suction source may connect to drain 120 and remove the fluid and sediment from storage tank 100 through drain 120 without exposure to air. In some embodiments, the suction source includes a hose to be connected from drain 120 to a sediment disposal container, such that the sediment may be removed from storage tank 100 and placed within the sediment disposal container without exposure to air. This may be advantageous where the sediment includes iron sulfide, which may ignite when exposed to air. The suction source may be connected to drain 120 by a clear nipple which indicates storage tank 100 is clean when the fluid sucked from the storage tank no longer appears to carry sediment. For example, where the fluid pumped into storage tank 100 is water, storage tank 100 is clean and may be returned to operation when the clear nipple shows the water running clear.

In some embodiments including an external suction source applied to drain 120, any lines into and out of the storage tank 100 under a predetermined height except for the one or more nozzles 110A-N are sealed before the suction is applied to drain 120. Because lines into and out of the storage tank 100 above the predetermined height remain open, pressure within the tank is equalized. The predetermined height may be selected any number of ways based at least in part on the configuration of nozzles 110A-N and lines into and out of storage tank 100. For example, the predetermined height may be selected based on the estimated volume of sediment within storage tank 100 and the estimated volume of fluid necessary to dislodge and flush the sediment out of storage tank 100. To illustrate, if the sediment within storage tank 100 is estimated at three feet high and the fluid necessary to clean the sediment out of storage tank 100 is estimated to be two feet, the predetermined height may be set at five feet.

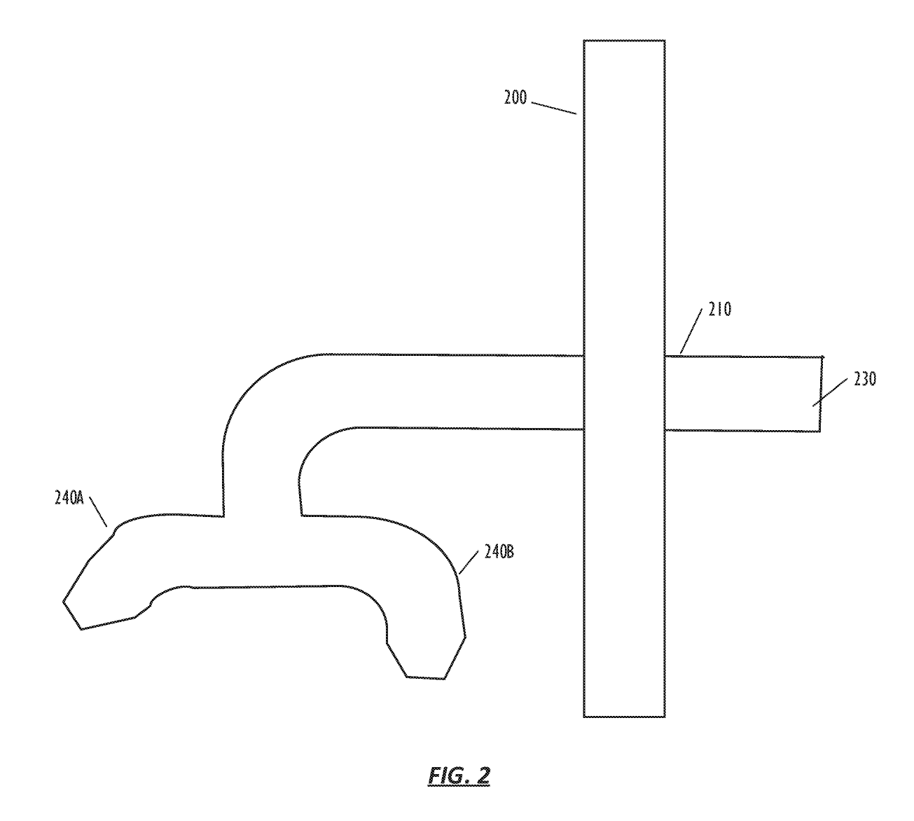

Referring to FIG. 2, a close-up view of an example nozzle 210 in a storage tank 200 is shown. Example nozzle 210 includes sub-nozzles 240A-B and external connection point 230. As discussed previously with reference to FIG. 1, the number and positioning of the one or more sub-nozzles may be chosen to optimize fluid pressure for creating a vortex and dislodging sediment from storage tank 200 and further to facilitate draining of the fluid and sediment through a drain in storage tank 200 by decreasing the likelihood of blockages in the drain. The size of storage tank 200 and the drain, the height of the one or more nozzles 210 off the bottom of storage tank 200, the type of sediment, and the like may be considered in choosing the number and position of the one or more sub-nozzles 240. The position of sub-nozzle 240A directs fluid towards the drain in storage tank 200 to encourage the flow of fluid and sediment and decrease the likelihood of blockages in the drain line by sediment build up. Sub-nozzle 240A may be positioned 45-90 degrees inward towards the center of storage tank 200 from the tangent line to the circumference. For example, sub-nozzle 240A may be positioned 22.5 degrees inward towards the center of storage tank 200 from the tangent line to the circumference. Sub-nozzle 240B is positioned to direct fluid flow perpendicular to the wall of storage tank 200 to aid in creating a vortex and dislodging sediment within storage tank 200. External connection point 230 connects the nozzle 210 through the wall of storage tank 200 to the outside and allows external fluid sources and pumps to connect to nozzle 210. These external fluid sources and pumps connect to external connection point 230 and pump fluid through nozzle 210 into storage tank 200 to clean it. In some embodiments, external connection point 230 may be sealed when storage tank 200 is in use, such that the external fluid sources and pumps may be disconnected and used elsewhere as needed. When storage tank 200 must be cleaned, the external fluid sources and pumps may be reconnected to external connection point 230, which is opened, allowing the fluid to be pumped through nozzle 210.

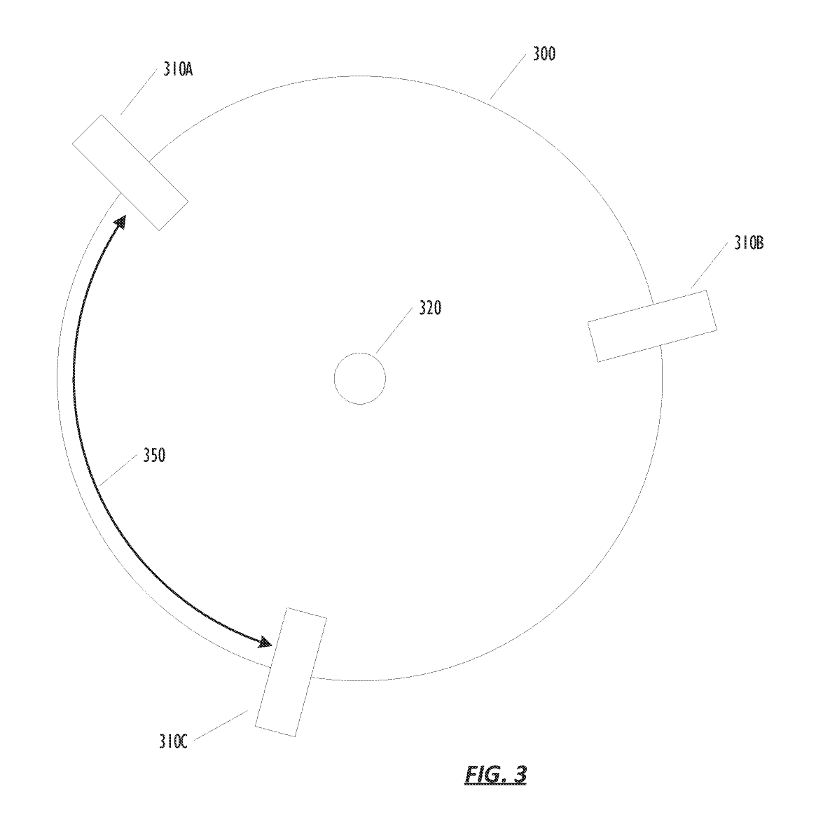

Referring to FIG. 3, an overhead view of the arrangement of nozzles 310A-C and drain 320 in an example storage tank 300 is shown. Storage tank 300 is cylindrical with three nozzles 310A-C spaced 120 degrees apart around the wall and six inches from the bottom of storage tank 300. Drain 320 is placed at the bottom of storage tank 300 to allow for removal of the water and sediment from storage tank 300 without exposure to air. If drain 320 were placed on the wall instead of the bottom of storage tank 300, the suction source would eventually suck up air from within storage tank 300 once the fluid and sediment level is below the height of drain 320 from the bottom of storage tank 300. In one embodiment, a 4×3 centrifugal pump may be used to pump water through nozzles 310A-C at a rate of 880 gallons per minute allowing storage tank 300 to be cleaned more quickly than traditional methods, which require days of disuse.

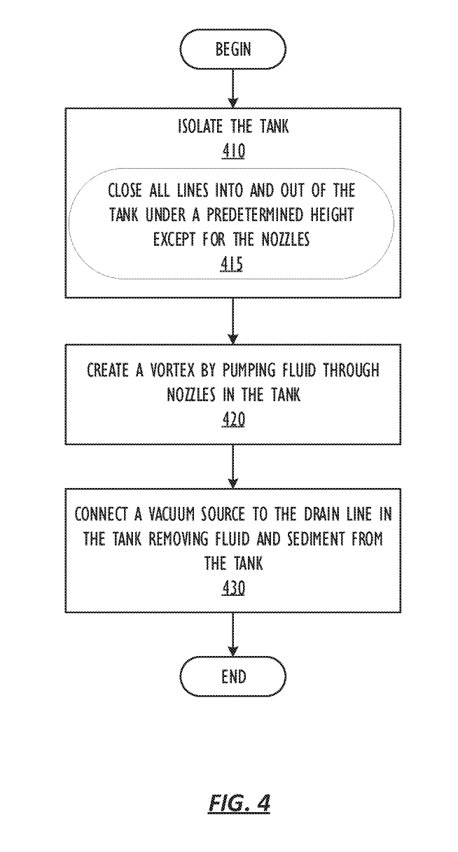

FIG. 4 shows, in flow chart form, an example process for cleaning a storage tank. The flow chart begins at step 410, where the storage tank is isolated. When the particular storage tank is included in a tank battery, isolating the particular storage tank allows the other tanks in the tank battery to continue operating while the particular tank is cleaned. Isolating the storage tank may optionally include step 415, where all lines into and out of the storage tank under a predetermined height except for the one or more nozzles are closed. Because lines into and out of the storage tank above the predetermined height remain open, pressure within the tank is equalized. As discussed previously, the predetermined height may be selected any number of ways. Next, at step 420, a vortex may be created within the storage tank by pumping fluid through the one or more nozzles in the storage tank. As discussed previously, the nozzles may comprise two or more sub-nozzles positioned to dislodge sediment within the storage tank and keep the drain in the storage tank clear of blockages. The process continues at step 430, where a vacuum source is connected to the drain in the storage tank to remove the fluid and sediment from the storage tank. As discussed previously, where the drain is located at the bottom of the storage tank, the fluid and sediment may be removed from the storage tank without exposure to air. This may be advantageous where the sediment includes iron sulfide, which ignites when exposed to air, because it reduces the associated fire hazard.

The scope of the inventions contained within the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A method for cleaning a storage tank, comprising:
isolating the tank;
creating a vortex within the tank by pumping fluid through one or more nozzles disposed within the tank, thereby dislodging sediment within the tank; and
connecting a suction source to a drain located on a bottom of the tank, thereby removing the fluid and sediment from the tank without exposure to air.

2. The method of claim 1, wherein isolating the tank comprises closing all lines into and out of the tank under a predetermined height except for the one or more nozzles and wherein the predetermined height is determined based on at least an anticipated height of sediment build-up and an anticipated volume of fluid needed to dislodge the sediment.

3. The method of claim 1, wherein the one or more nozzles comprise three nozzles.

4. The method of claim 3, wherein the tank is cylindrical and the three nozzles are placed 120 degrees apart around a wall of the tank.

5. The method of claim 1, wherein the one or more nozzles each comprise one or more sub-nozzles.

6. The method of claim 5, wherein the one or more nozzles each comprise two sub-nozzles.

7. The method of claim 6, wherein a first sub-nozzle is positioned to direct fluid flow perpendicular to a wall of the tank.

8. The method of claim 7, wherein a second sub-nozzle is positioned to direct fluid flow 22.5 degrees inward towards a center of the tank compared to the first sub-nozzle.

9. The method of claim 1, wherein the tank is included in a tank battery and wherein the tank is cleaned without affecting operation of other tanks in the tank battery.

10. The method of claim 1, wherein the one or more nozzles are disposed within the tank at a height of six inches from the bottom of the tank.

11. A storage tank, comprising:
one or more nozzles disposed within the tank such that fluid may be pumped through the one or more nozzles to create a vortex within the tank; and
a drain line located on a bottom of the tank such that a suction source may be connected and contents of the tank removed without exposure to air.

12. The storage tank of claim 11, wherein the one or more nozzles comprise three nozzles.

13. The storage tank of claim 12, wherein the tank is a cylinder and the three nozzles are placed 120 degrees apart around a wall of the tank.

14. The storage tank of claim 11, wherein the one or more nozzles each comprise two sub-nozzles.

15. The storage tank of claim 14, wherein a first sub-nozzle is positioned to direct fluid flow perpendicular to a wall of the tank.

16. The storage tank of claim 15, wherein a second sub-nozzle is positioned to direct fluid flow 22.5 degrees inward towards a center of the tank compared to the first sub-nozzle.

17. The storage tank of claim 11, wherein the one or more nozzles are disposed within the tank at a height of six inches from a bottom of the tank.

18. A nozzle assembly for cleaning a storage tank, the nozzle assembly comprising one or more nozzles configured to be located within the storage tank such that a fluid pumped through the one or more nozzles will induce a vortex within the storage tank.

19. The nozzle assembly of claim 18, wherein each of the one or more nozzles comprises one or more sub-nozzles.

20. The nozzle assembly of claim 19, wherein each of the one or more sub-nozzles is positioned to aid in inducement of the vortex within the storage tank.
